(19) United States
(12) Patent Application Publication
(10) Pub. No.: US 2007/0115960 A1
(43) Pub. Date: May 24, 2007

(54) De-interleaver for data decoding

(75) Inventor: Shih-Chung Yin, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/267,752

(22) Filed: Nov. 4, 2005

(51) Int. Cl. H04L 12/56

(52) U.S. Cl. 370/389

(57) ABSTRACT

A de-interleaver for data decoding. Two memory banks are configured to store data in column order and output the data in row order. A de-interleaving encoder receives a stream of interleaved data values, generates an input address for both the two memory banks contingent upon a modulation mode and based on a count value, and sequentially writes the interleaved data values to either of the memory banks according to the input address. Additionally, a de-interleaving decoder generates respective output addresses for the two memory banks based on a second count value and contingent upon the modulation mode, and a dummy insertion indicator. The de-interleaving decoder reads the interleaved data values from the two memory banks according to the respective output address, and extracts decision metrics from the read data according to relevant output indicators.

### BACKGROUND

The invention relates to communications systems, and more particularly to communications systems and methods that use de-interleaving.

With the rapidly growing demand for cellular, mobile radio and other wireless transmission services, there has been an increasing interest in exploiting various technologies to provide reliable, secure, and efficient wireless communications. Orthogonal Frequency Division Multiplexing (OFDM) is well known as a high spectrally efficient transmission scheme capable of dealing with severe channel impairment encountered in a mobile environment. OFDM has been adopted for wireless local area network (WLAN) applications as part of the IEEE 802.11a standard in the 5 GHz frequency band. In June of 2003, the IEEE approved another WLAN standard, known as 802.11g, which also adopts OFDM as a mandatory part for a further high-speed physical layer (PHY) extension to the 802.11b standard in the 2.4 GHz band. The advantages of OFDM have become well known and applications of similar modulation techniques, namely multi-carrier modulation techniques, are under consideration for use in new standards. Although the multi-carrier modulation techniques used in different standards may have differences, the basic idea of using multiple subcarriers to transmit data is a foundation of all multi-carrier modulation techniques.

Multi-carrier communications systems are susceptible to continuous sequences of erroneous bits, or burst errors. It is common to use interleaving in communications systems to overcome correlated channel noise such as burst errors or fading. An interleaver disperses contiguous bits of data in a data stream across a transmission sequence so that data bits adjacent in the data stream are no longer adjacent in the transmission sequence. At the receiving end, the interleaved data is rearranged into its original order by a de-interleaver prior to further processing. As a result of interleaving, correlated channel noise introduced in the transmission channel appears to be statistically independent at the receiving end and thus allows superior error correction. Interleavers and de-interleavers are disclosed, for example, in U.S. Pat. No. 6,634,009 and U.S. Pat. No. 6,748,561. One of the greatest challenges facing those devising multi-carrier communications systems is implementation of an efficient and economical interleaver/de-interleaver.

### SUMMARY

Systems and methods involving de-interleaving are provided. In this regard, an embodiment of a de-interleaver comprises a first and second memory bank, a de-interleaving encoder, and a de-interleaving decoder. The first and the second memory banks are configured to store data in column order and output the data in row order. The de-interleaving encoder receives a stream of interleaved data values, and generates an input address for both the first and the second memory banks contingent upon a modulation mode and based on a first count value. According to the input address, the de-interleaving encoder sequentially writes the interleaved data values to either the first memory bank or the second memory bank in column order. On the other hand, the de-interleaving decoder generates a first output address for the first memory bank and a second output address for the second memory bank based on a second count value and contingent upon the modulation mode, a coding rate, and a dummy insertion indicator. According to the respective output addresses, the de-interleaving decoder sequentially reads the interleaved data values from the first and the second memory banks in row order. Furthermore, the de-interleaving decoder extracts decision metrics from the interleaved data values read out of the memory banks according to a first output indicator and a second output indicator.

In another aspect, an embodiment of a multi-carrier communications system comprises a de-interleaver for data decoding. The de-interleaver comprises a first and second memory bank, a de-interleaving encoder, and a de-interleaving decoder. The first and the second memory banks are configured to store data in column order and output the data in row order. The de-interleaving encoder receives a stream of interleaved data values, and generates an input address for both the first and the second memory banks contingent upon a modulation mode and based on a first count value. According to the input address, the interleaved data values are sequentially written to either the first memory bank or the second memory bank in column order. On the other hand, the de-interleaving decoder generates a first output address for the first memory bank and a second output address for the second memory bank based on a second count value and contingent upon the modulation mode, a coding rate, and a dummy insertion indicator. According to the respective output addresses, the interleaved data values are sequentially read from the first and the second memory banks in row order. Furthermore, the de-interleaving decoder extracts decision metrics from the interleaved data values read out of the memory banks according to a first output indicator and a second output indicator.

### BRIEF DESCRIPTION OF THE DRAWINGS

The invention will be described by way of exemplary embodiments, but not limitations, illustrated in the accompanying drawings in which like references denote similar elements, and in which:

FIG. 1 is a block diagram illustrating an embodiment of a multi-carrier communications system;

FIG. 2 is a block diagram of an 8-column by 3-row memory, which stores sequential data bits D1-D24 in column order;

FIG. 3 is an exemplary graph illustrating signal waveforms with respect to a de-interleaving encoder involved in the multi-carrier communications system of FIG. 1; and

FIG. 4 is an exemplary graph illustrating signal waveforms with respect to a de-interleaving decoder involved in the multi-carrier communications system of FIG. 1.

### DETAILED DESCRIPTION

Reference throughout this specification to “one embodiment” or “an embodiment” indicates that a particular feature, structure, or characteristic described in connection with the embodiments is included in at least one embodiment of the present invention. Thus, the appearance of the phrases “in one embodiment” or “an embodiment” in various places throughout this specification is not necessarily all referring to the same embodiment. Furthermore, the particular features, structures, or characteristics may be combined in one or more embodiments. As to the accompanying drawings, it should be appreciated that not all components necessary for a complete implementation of a practical system may be illustrated or described in detail.

To complement OFDM, the IEEE 802.11a/g standard also offers support for a variety of other modulation and coding alternatives. For example, the standard allows designers to combine BPSK, QPSK, and 16-QAM modulation with convolution encoding at a rate of R=½ to generate data rates of 6, 12 and 24 Mbps. All other combinations of coding rate, including R=⅔ and R=¾ combined with 64-QAM, are used to generate rates up to 54 Mbps, which are optional in the standard. The coding rate of ½ can be increased to ⅔ and ¾ by means of puncturing. Puncturing is a bit-stealing procedure for omitting some of encoded bits in the transmitter, thereby reducing the number of transmitted bits and achieving higher data rate. After puncturing, interleaving is applied to ensure that adjacent coded bits are separated by several bits, thus increasing noise immunity to burst errors. According to the standard, all data bits must be interleaved by a block interleaver with a block size corresponding to the number of bits in a single OFDM symbol, N_{CBPS}. The interleaver is defined by a two-step permutation. The first permutation ensures that adjacent coded bits are mapped onto non-adjacent subcarriers. The second ensures that adjacent coded bits are mapped alternately onto less and more significant bits of the constellation and, thereby, long runs of low reliability (LSB) bits are avoided. In the case of 802.11a, the first permutation is defined by:
i=(N_{CBPS}/16)(k mod 16)+floor(k/61), k=0,1, . . . ,N_{CBPS}−1
where k is the index of the coded bit, i is the index after the first permutation, floor(•) is a function returning the largest integer not exceeding the parameter, and mod denotes modulo arithmetic. The second permutation is of the form:
j=s×floor(i/s)+(i+N_{CBPS}−floor(16×i/N_{CBPS}))mod s, k=0,1, . . . , N_{CBPS}−1
where j is the index after the second permutation. The value of s is given by
s=max(N_{BPSC}/2,1)

where N_{BPSC} is the number of coded bits per subcarrier. The encoded and interleaved binary serial data are then divided into groups of N_{BPSC} bits and converted into complex numbers representing BPSK, QPSK, 16-QAM, or 64-QAM constellation points. The following table summarizes the modulation parameters of the IEEE standard 802.11a.

TABLE 1

| | | | Coding | | |
|---|---|---|---|---|---|
| | | | bits | Coding bits | Data bits |
| | | Coding | per sub- | per OFDM | per OFDM |
| Data Rate | | rate | carrier | symbol | symbol |
| (Mbits/s) | Modulation | (R) | (N_{BPSC}) | (N_{CBPS}) | (N_{DBPS}) |
| 6 | BPSK | ½ | 1 | 48 | 24 |
| 9 | BPSK | ¾ | 1 | 48 | 36 |
| 12 | QPSK | ½ | 2 | 96 | 48 |
| 18 | QPSK | ¾ | 2 | 96 | 72 |
| 24 | 16-QAM | ½ | 4 | 192 | 96 |
| 36 | 16-QAM | ¾ | 4 | 192 | 144 |
| 48 | 64-QAM | ⅔ | 6 | 288 | 192 |
| 54 | 64-QAM | ¾ | 6 | 288 | 216 |

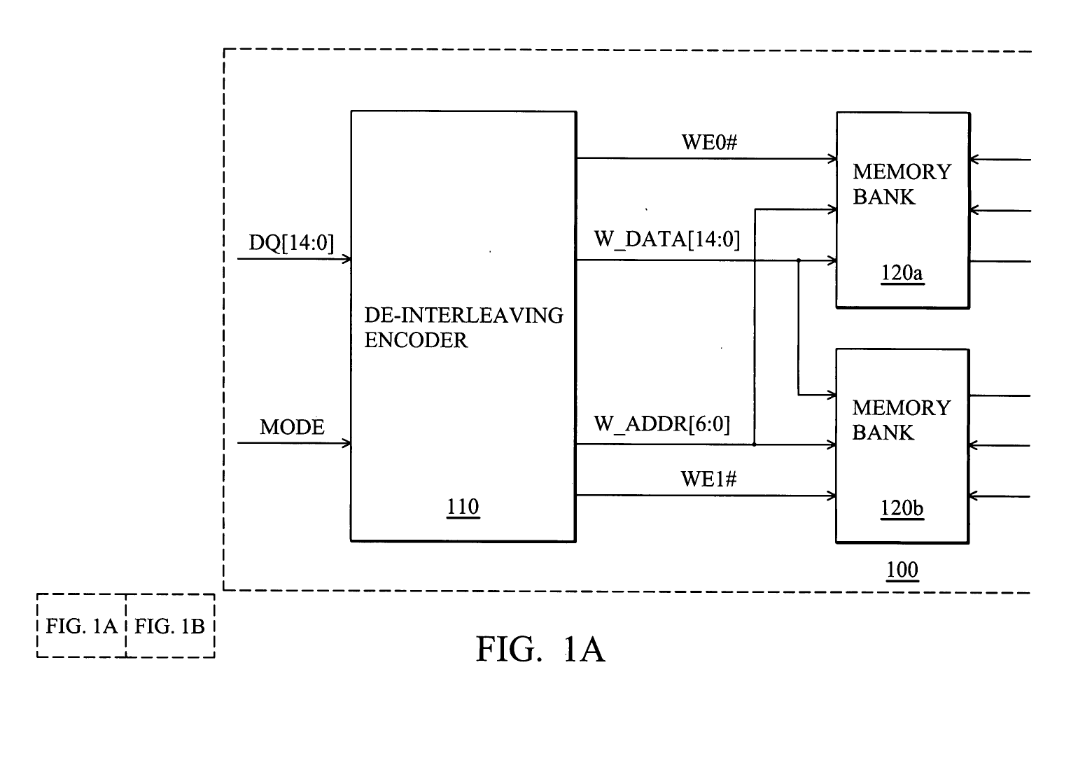

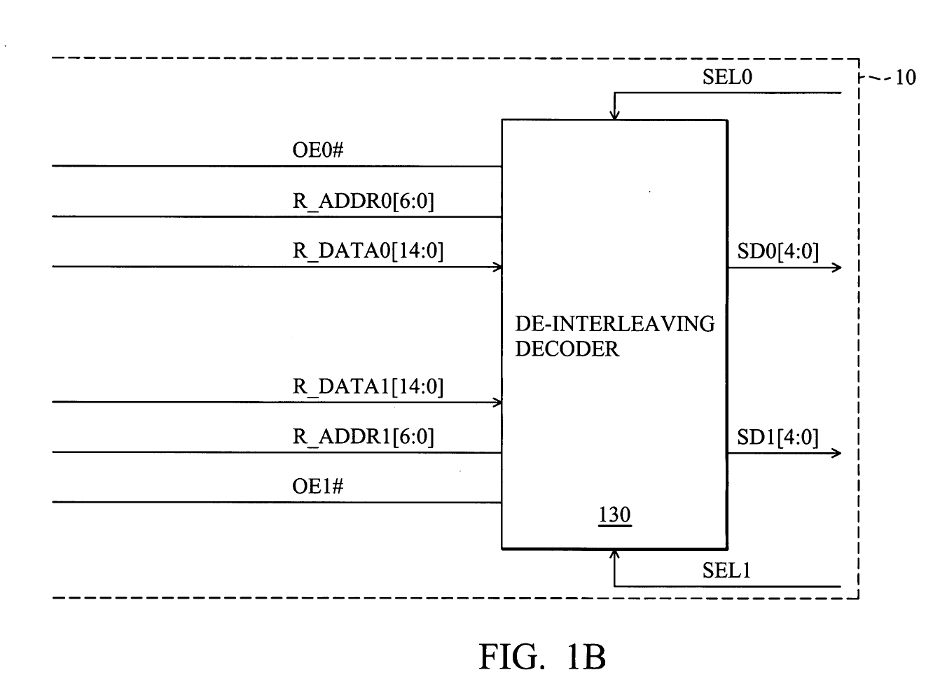

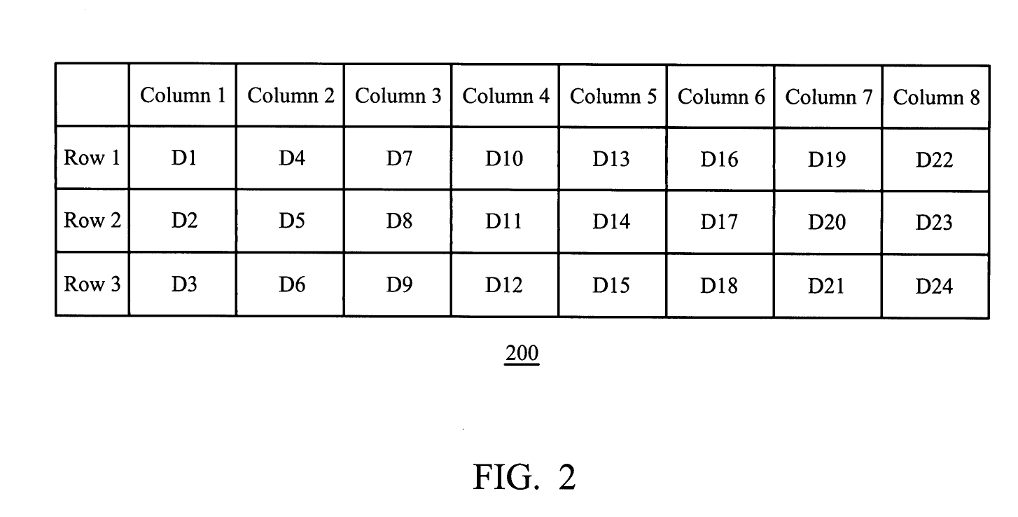

Basically, a conformant 802.11a receiver performs the reverse operations of transmission. Incoming data modulated by the form of phase shift keying (PSK) or quadrature amplitude modulation (QAM) can be de-mapped into binary values known as decision metrics and subjected to de-interleaving before entering a Viterbi decoder. A decision metric is deemed hard-decision data if it is quantized to one-bit precision, while a decision metric is deemed soft-decision data if quantized with more than one bit of precision. Referring now to FIG. 1, an embodiment of a conformant 802.11a system 10 involving a de-interleaver 100 for data decoding is illustrated by way of a block diagram. As depicted, an embodiment of the de-interleaver 100 comprises a de-interleaving encoder 110, two memory banks 120a-b, and a de-interleaving decoder 130. The memory banks 120a and 120b are configured to store data in column order and output the data in row order. As an example, sequential data values D1-D24 are written into an 8×3 memory 200 in column order as shown in FIG. 2. When the data values are sequentially read from rows 1, 2 and 3 of the memory 200 (i.e. in row order), the order of the data values D1-D24 is: D1, D4, D7, D10, D13, D16, D19, D22, D2, D5, D8, D11, D14, D17, D20, D23, D3, D6, D9, D12, D15, D18, D21, D24. The memory banks 120a and 120b constitute a sufficient capacity to accommodate an OFDM symbol modulated by different types. In one embodiment, each memory bank may comprise two pages so that while one is outputting an OFDM symbol, the other is storing the next symbol.

The de-interleaving encoder 110 receives a stream of interleaved data values DQ[14:0] representing decision metrics from a de-mapping module (not shown). An auxiliary signal MODE is also provided, informing the de-interleaving encoder 110 of the modulation mode being used. The interleaving encoder 110 generates an input address W_ADDR[6:0] for both the memory banks 120a and 120b contingent upon the modulation mode and based on a count value i. A cycle-based counter may be built in the de-interleaving encoder 110 to generate the count value i from 0 to (N_{CBPS}/s)−1, where s is determined by N_{BPSC} according to the expression: s=max(N_{BPSC}/2,1). In the case of a conformant 802.11a system, the value of s is 1, 1, 2, and 3 for BPSK, QPSK, 16-QAM, and 64-QAM modulation, respectively. In addition to the input address W_ADDR[6:0], the interleaving encoder 110 needs to generate write-enable signals WE0# and WE1# for the memory banks 120a and 120b, respectively. A #sign at the end of a signal name herein indicates that the active state occurs when the signal is at a logic low level. According to an embodiment of the interleaving encoder 110, the input address W_ADDR[6:0] and the write-enable signals WE0# and WE1# are generated from the following pseudo-code:

```
MODE = BPSK
    for i = 0, 1, 2,..., (N_{CBPS} / s) − 1
          WA_{MSB} [symbol] i mod 3
          WA_{LSB} [symbol] i / 6
          W_ADDR [symbol] {WA_{MSB}, WA_{LSB}}
          WE0# [symbol] (i / 3) mod 2
          WE1# [symbol] ˜((i / 3) mod 2)
MODE = QPSK
    for i = 0, 1, 2,..., (N_{CBPS} / s) − 1
          WA_{MSB} [symbol] i mod 6
          WA_{LSB} [symbol] i / 12
          W_ADDR [symbol] {WA_{MSB}, WA_{LSB}}
          WE0# [symbol] (i / 6) mod 2
          WE1# [symbol] ˜((i / 6) mod 2)
MODE = 16-QAM
    for i = 0, 1, 2,..., (N_{CBPS} / s) − 1
          WA_{MSB} [symbol] i mod 6
          WA_{LSB} [symbol] i / 12
          W_ADDR [symbol] {WA_{MSB}, WA_{LSB}}
          REV [symbol] (i / 6) mod 2
          WE0# [symbol] (i / 6) mod 2
          WE1# [symbol] ˜((i / 6) mod 2)
MODE = 64-QAM
    for i = 0, 1, 2,..., (N_{CBPS} / s) − 1
          WA_{MSB} [symbol] i mod 6
          WA_{LSB} [symbol] i / 12
          W_ADDR [symbol] {WA_{MSB}, WA_{LSB}}
          REV [symbol] (i / 6) mod 3
          WE0# [symbol] (i / 6) mod 2
          WE1# [symbol] ˜(i / 6) mod 2)
```

As can be seen, WA_{MSB}[6:3] and WA_{LSB}[2:0] are concatenated into W_ADDR[6:0], yielding the input address for both the memory banks 120a 120b. Hence, the interleaved data values are written to either the memory bank 120a or 120b in column order according to the address W_ADDR[6:0]. Note that the de-interleaving encoder 110 further generates a reverse indicator REV in the case of quadrature amplitude modulation, and if necessary, permutes the order of the bits of the interleaved data values in advance according to the reverse indicator REV. In this regard, the actual order of the bits of data values written to the memory banks is determined by the rule:

```
MODE = 16-QAM
    if (REV = 0)
          W_DATA[14:0] [symbol] DQ[14:0]
    else if (REV = 1)
          W_DATA[14:0] [symbol] {DQ[14:10], DQ[4:0], DQ[9:5]}
MODE = 64-QAM
    if (REV = 0)
          W_DATA[14:0] [symbol] DQ[14:0]
    else if (REV = 1)
          W_DATA[14:0] [symbol] {DQ[9:5], DQ[4:0], DQ[14:10]}
    else if (REV = 2)
          W_DATA[14:0] [symbol] {DQ[4:10], DQ[14:0], DQ[9:5]}
```

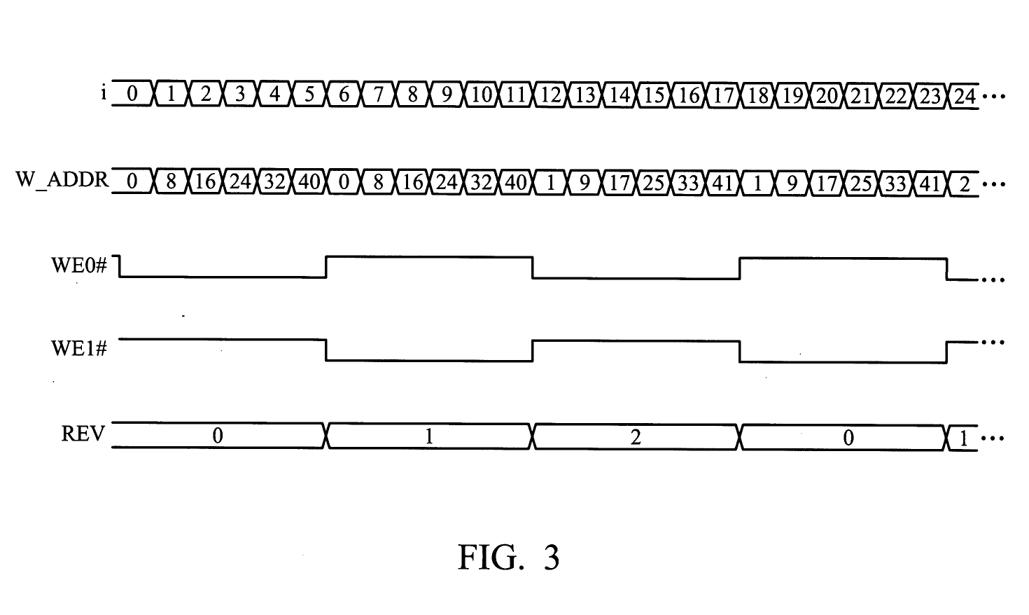

As an example helpful in understanding the de-interleaving encoder 110, FIG. 3 shows a waveform graph of related signals in the case where the MODE signal is indicative of 64-QAM modulation.

The de-interleaver 100 may insert dummy data into the subsequent Viterbi decoder (not shown) in place of the previously punctured bits at the transmitting end. Specifically, the de-interleaving decoder 130 takes dummy insertion into account when it attempts to read decision metrics out of the memory banks. Therefore, the de-interleaving decoder 130 generates an output address R_ADDR0[6:0] for the memory bank 120a and another output address R_ADDR1[6:0] for the memory bank 120b based on a count value n and contingent upon the modulation mode, a coding rate, and a dummy insertion indicator (abbreviated as DII). In addition, the interleaving decoder 130 needs to generate output-enable signals OE0# and OE1# for the memory banks 120a and 120b, respectively. According to an embodiment of the interleaving decoder 130, the output address R_ADDR0[6:0], the output address R_ADDR1[6:0], the output-enable signal OE0#, and the output-enable signal OE1# are generated as follows:

```
MODE = BPSK and RATE = 1 / 2
    for n = 0, 1, 2,..., N_{DBPS} − 1
          if (DII = 00)
                RA_{MSB} [symbol] n / 8
                RA0_{LSB} [symbol] n mod 8
                RA1_{LSB} [symbol] n mod 8
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 0
MODE = BPSK and RATE = 3 / 4
    for n = 0, 1, 2,..., N_{DBPS} − 1
          if (DII = 00)
                RA_{MSB} [symbol] n / 12
                RA0_{LSB} [symbol] (n × 2 / 3) mod 8
                RA1_{LSB} [symbol] (n × 2 / 3) mod 8
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 0
          else if (DII = 01)
                RA_{MSB} [symbol] n / 12
                RA0_{LSB} [symbol] RA0_{LSB} + 1
                RA1_{LSB} [symbol] RA1_{LSB}
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 1
          else if (DII = 10)
                RA_{MSB} [symbol] n / 12
                RA0_{LSB} [symbol] RA0_{LSB}
                RA1_{LSB} [symbol] RA1_{LSB} + 1
                R_ADDR0 [symbol] {RA_{MSB}, RA0_{LSB}}
                R_ADDR1 [symbol] {RA_{MSB}, RA1_{LSB}}
                OE0# [symbol] 1
                OE1# [symbol] 0
MODE = QPSK and RATE = 1 / 2
    for n = 0, 1, 2,..., N_{DBPS} − 1
          if (DII = 00)
                RA_{MSB} [symbol] n / 8
                RA0_{LSB} [symbol] n mod 8
                RA1_{LSB} [symbol] n mod 8
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 0
MODE = QPSK and RATE = 3 / 4
    for n = 0, 1, 2,..., N_{DBPS} − 1
          if (DII = 00)
                RA_{MSB} [symbol] n / 12
                RA0_{LSB} [symbol] (n × 2 / 3) mod 8
                RA1_{LSB} [symbol] (n × 2 / 3) mod 8
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 0
          else if (DII = 01)
                RA_{MSB} [symbol] n / 12
                RA0_{LSB} [symbol] RA0_{LSB} + 1
                RA1_{LSB} [symbol] RA1_{LSB}
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 1
          else if (DII = 10)
                RA_{MSB} [symbol] n / 12
                RA0_{LSB} [symbol] RA0_{LSB}
                RA1_{LSB} [symbol] RA1_{LSB} + 1
                R_ADDR0 [symbol] {RA_{MSB}, RA0_{LSB}}
                R_ADDR1 [symbol] {RA_{MSB}, RA1_{LSB}}
                OE0# [symbol] 1
                OE1# [symbol] 0
MODE = 16-QAM and RATE = 1 / 2
    for n = 0, 1, 2,..., N_{DBPS} − 1
          if (DII = 00)
                RA_{MSB} [symbol] n / 16
                RA0_{LSB} [symbol] n mod 8
                RA1_{LSB} [symbol] n mod 8
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 0
MODE = 16-QAM and RATE = 3 / 4
    for n = 0, 1, 2,..., N_{DBPS} − 1
          if (DII = 00)
                RA_{MSB} [symbol] n / 24
                RA0_{LSB} [symbol] (n × 2 / 3) mod 8
                RA1_{LSB} [symbol] (n × 2 / 3 ) mod 8
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 0
          else if (DII = 01)
                RA_{MSB} [symbol] n / 24
                RA0_{LSB} [symbol] RA0_{LSB} + 1
                RA1_{LSB} [symbol] RA1_{LSB}
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 1
          else if (DII = 10)
                RA_{MSB} [symbol] n / 24
                RA0_{LSB} [symbol] RA0_{LSB}
                RA1_{LSB} [symbol] RA1_{LSB} + 1
                R_ADDR0 [symbol] {RA_{MSB}, RA0_{LSB}}
                R_ADDR1 [symbol] {RA_{MSB}, RA1_{LSB}}
                OE0# [symbol] 1
                OE1# [symbol] 0
MODE = 64-QAM and RATE = 2 / 3
    for n = 0, 1, 2,..., N_{DBPS} − 1
          if (DII = 00)
                RA_{MSB} [symbol] n / 32
                RA0_{LSB} [symbol] (n × 3 / 4) mod 8
                RA1_{LSB} [symbol] (n × 3 / 4) mod 8
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 0
          else if (DII = 01)
                RA_{MSB} [symbol] n / 32
                RA0_{LSB} [symbol] RA0_{LSB} + 1
                RA1_{LSB} [symbol] RA1_{LSB}
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 1
          else if (DII = 11)
                RA_{MSB} [symbol] n / 32
                RA0_{LSB} [symbol] RA0_{LSB} + 1
                RA1_{LSB} [symbol] RA1_{LSB} + 1
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 1
          else if (DII = 10)
                RA_{MSB} [symbol] n / 32
                RA0_{LSB} [symbol] RA0_{LSB}
                RA1_{LSB} [symbol] RA1_{LSB} + 1
                R_ADDR0 [symbol] {RA_{MSB}, RA0_{LSB}}
                R_ADDR1 [symbol] {RA_{MSB}, RA1_{LSB}}
                OE0# [symbol] 1
                OE1# [symbol] 0
MODE = 16-QAM and RATE = 3 / 4
    for n = 0, 1, 2,..., N_{DBPS} − 1
          if (DII = 00)
                RA_{MSB} [symbol] n / 36
                RA0_{LSB} [symbol] (n × 2 / 3) mod 8
                RA1_{LSB} [symbol] (n × 2 / 3) mod 8
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 0
          else if (DII = 01)
                RA_{MSB} [symbol] n / 36
                RA0_{LSB} [symbol] RA0_{LSB} + 1
                RA1_{LSB} [symbol] RA1_{LSB}
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 1
          else if (DII = 10)
                RA_{MSB} [symbol] n / 36
                RA0_{LSB} [symbol] RA0_{LSB}
                RA1_{LSB} [symbol] RA1_{LSB} + 1
                R_ADDR0 [symbol] {RA_{MSB}, RA0_{LSB}}
                R_ADDR1 [symbol] {RA_{MSB}, RA1_{LSB}}
                OE0# [symbol] 1
                OE1# [symbol] 0
```

As can be seen, RA_{MSB}[6:3] and RA0_{LSB}[2:0] are concatenated into R_ADDR0[6:0], yielding the output address for the memory bank 120a. Likewise, RA_{MSB}[6:3] and RA1_{LSB}[2:0] are concatenated into R_ADDR1[6:0], yielding the output address for the memory bank 120b. Note that a cycle-based counter may, be built in the de-interleaving decoder 130 to generate the count value n from 0 to N_{DBPS}−1. According to R_ADDR0[6:0], R_ADDR1[6:0], OE0#, and OE1#, the memory banks 120a and 120b send out the data values addressed and place them onto R_DATA0[14:0] and R_DATA1[14:0], leading the de-interleaving decoder 130 to sequentially read the interleaved data values from the memory banks 120a and 120b in row order. In this manner, a stream of N_{CBPS} interleaved data can be restored to its original order in N_{DBPS} cycles.

There are two more auxiliary signals SEL0 and SEL1 applied to the de-interleaving decoder 130. The SEL0 and SEL1 signals are output indicators dictating which portion of the read data is the final output, such as that described in the following:

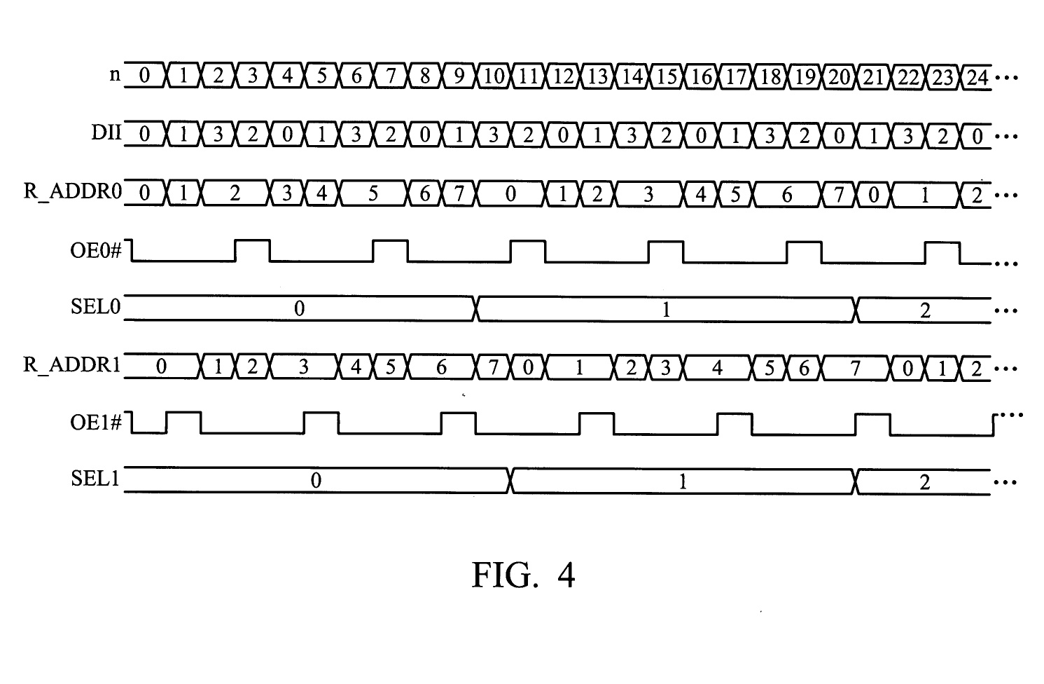

case(SELx)
0: SDx[4:0]←R_DATAx[4:0]
1: SDx[4:0]←R_DATAx[9:5]
2: SDx[4:0]←R_DATAx[14:10]
   where x denotes 0 or 1. The output indicator SELx may be a modulo-s counter where the value of s is determined by the expression: S=max(N_{BPSC}/2,1). Every eight read operations increase the output indicator SELx by one. According to the output indicators SEL0 and SEL1, the de-interleaving decoder 130 is thus able to extract desired portions from the interleaved data values read out of the memory banks 120a and 120b for use as decision metrics. As an example helpful in understanding the de-interleaving decoder 130, FIG. 4 shows a waveform graph of related signals in the case of MODE=64-QAM and RATE=⅔.

An embodiment of a de-interleaver 100 has been described above in the context of the use of OFDM for communication, although relevant embodiments are not limited to OFDM. The embodiment is also described with reference to a wireless communications system that conforms to the IEEE 802.11a/g standard. However, the communications system need not be wireless and the conformant 802.11a system referred to herein is merely an example of multi-carrier communications equipment.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A de-interleaver comprising:
first and second memory banks configured to store data in column order and output the data in row order;
a de-interleaving encoder receiving a stream of interleaved data values, generating an input address for both the first and the second memory banks contingent upon a modulation mode and based on a first count value, and sequentially writing the interleaved data values to either the first memory bank or the second memory bank in column order according to the input address; and
a de-interleaving decoder generating a first output address for the first memory bank and a second output address for the second memory bank based on a second count value and contingent upon the modulation mode, a coding rate, and a dummy insertion indicator, reading the interleaved data values from the first and the second memory banks in row order according to the first output address and the second output address, respectively, and extracting decision metrics from the interleaved data values read out of the first and the second memory banks, according to a first output indicator and a second output indicator.

2. The de-interleaver as set forth in claim 1, wherein the de-interleaving encoder further generates first and second write-enable signals for the first and the second memory banks, respectively.

3. The de-interleaver as set forth in claim 2, wherein when the modulation mode is BPSK modulation, the de-interleaving encoder generates the input address, the first and the second write-enable signals, as described in the following pseudo-code:
```
for i = 0, 1, 2,..., N_{CBPS} − 1
        WA_{MSB} [symbol] i mod 3
        WA_{LSB} [symbol] i / 6
        W_ADDR [symbol] {WA_{MSB}, WA_{LSB}}
        WE0# [symbol] (i / 3) mod 2
        WE1# [symbol] ˜((i / 3) mod 2)
```
where
i denotes the first count value,
WA_{MSB} and WA_{LSB} are concatenated into W_ADDR, yielding the input address for both the first and the second memory banks,
WE0# denotes the first write-enable signal,
WE1# denotes the second write-enable signal, and
N_{CBPS} is a prescribed number.

4. The de-interleaver as set forth in claim 2, wherein when the modulation mode is QPSK modulation, the de-interleaving encoder generates the input address, the first and the second write-enable signals, as described in the following pseudo-code:
```
for i = 0, 1, 2,..., N_{CBPS} − 1
        WA_{MSB} [symbol] i mod 6
        WA_{LSB} [symbol] i / 12
        W_ADDR [symbol] {WA_{MSB}, WA_{LSB}}
        WE0# [symbol] (i / 6) mod 2
        WE1# [symbol] ˜((i / 6) mod 2)
```
where
i denotes the first count value,
WA_{MSB} and WA_{LSB} are concatenated into W_ADDR, yielding the input address for both the first and the second memory banks,
WE0# denotes the first write-enable signal,
WE1# denotes the second write-enable signal, and
N_{CBPS} is a prescribed number.

5. The de-interleaver as set forth in claim 2, wherein the de-interleaving encoder further generates a reverse indicator, and, if necessary, permutes the order of the bits of the interleaved data values in advance according to the reverse indicator.

6. The de-interleaver as set forth in claim 5, wherein when the modulation mode is 16-QAM modulation, the de-interleaving encoder generates the input address, the reverse indicator, the first and the second write-enable signals, as described in the following pseudo-code:
```
for i = 0, 1, 2,..., (N_{CBPS} / 2) − 1
        WA_{MSB} [symbol] i mod 6
        WA_{LSB} [symbol] i / 12
        W_ADDR [symbol] {WA_{MSB}, WA_{LSB}}
        REV [symbol] (i / 6) mod 2
        WE0# [symbol] (i / 6) mod 2
        WE1# [symbol] ˜((i / 6) mod 2)
```
where
i denotes the first count value,
WA_{MSB} and WA_{LSB} are concatenated into W_ADDR, yielding the input address for both the first and the second memory banks,
REV denotes the reverse indicator,
WE0# denotes the first write-enable signal,
WE1# denotes the second write-enable signal, and
N_{CBPS} is a prescribed number.

7. The de-interleaver as set forth in claim 5, wherein when the modulation mode is 64-QAM modulation, the de-interleaving encoder generates the input address, the reverse indicator, the first and the second write-enable signals, as described in the following pseudo-code:
```
for i = 0, 1, 2,..., (N_{CBPS} / 3) − 1
        WA_{MSB} [symbol] i mod 6
        WA_{LSB} [symbol] i / 12
        W_ADDR [symbol] {WA_{MSB}, WA_{LSB}}
        REV [symbol] (i / 6) mod 3
        WE0# [symbol] (i / 6) mod 2
        WE1# [symbol] ˜((i / 6) mod 2)
```
where
i denotes the first count value,
WA_{MSB} and WA_{LSB} are concatenated into W_ADDR, yielding the input address for both the first and the second memory banks,
REV denotes the reverse indicator,
WE0# denotes the first write-enable signal,
WE1# denotes the second write-enable signal, and
N_{CBPS} is a prescribed number.

8. The de-interleaver as set forth in claim 1, wherein the de-interleaving decoder further generates first and second output-enable signals for the first and the second memory banks, respectively.

9. The de-interleaver as set forth in claim 8, wherein when the modulation mode is BPSK modulation and the coding rate is ½, the de-interleaving decoder generates the first output address, the second output address, the first output-enable signal, and the second output-enable signal, as described in the following pseudo-code:
```
for n = 0, 1, 2,..., N_{DBPS} − 1
        RA_{MSB} [symbol] n / 8
        RA0_{LSB} [symbol] n mod 8
        RA1_{LSB} [symbol] n mod 8
        R_ADDR0 [symbol] {RA_{MSB}, RA0_{LSB}}
        R_ADDR1 [symbol] {RA_{MSB}, RA1_{LSB}}
        OE0# [symbol] 0
        OE1# [symbol] 0
```
where
n denotes the second count value,
RA_{MSB} and RA0_{LSB} are concatenated into R_ADDR0, yielding the first output address for the first memory bank,
RA_{MSB} and RA1_{LSB} are concatenated into R_ADDR1, yielding the second output address for the second memory bank,
OE0# denotes the first output-enable signal,
OE1# denotes the second output-enable signal, and
N_{DBPS} is a prescribed number.

10. The de-interleaver as set forth in claim 8, wherein when the modulation mode is BPSK modulation and the coding rate is ¾, the de-interleaving decoder generates the first output address, the second output address, the first output-enable signal, and the second output-enable signal, as described in the following pseudo-code:
```
for n = 0, 1, 2,..., N_{DBPS} − 1
        if (DII = 00)
                RA_{MSB} [symbol] n / 12
                RA0_{LSB} [symbol] (n × 2 / 3) mod 8
                RA1_{LSB} [symbol] (n × 2 / 3) mod 8
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 0
        else if (DII = 01)
                RA_{MSB} [symbol] n / 12
                RA0_{LSB} [symbol] RA0_{LSB} + 1
                RA1_{LSB} [symbol] RA1_{LSB}
                R_ADDR0 [symbol] {RA_{MSB}, RA0_{LSB}}
                R_ADDR1 [symbol] {RA_{MSB}, RA1_{LSB}}
                OE0# [symbol] 0
                OE1# [symbol] 1
        else if (DII = 10)
                RA_{MSB} [symbol] n / 12
                RA0_{LSB} [symbol] RA0_{LSB}
                RA1_{LSB} [symbol] RA1_{LSB} + 1
                R_ADDR0 [symbol] {RA_{MSB}, RA0_{LSB}}
                R_ADDR1 [symbol] {RA_{MSB}, RA1_{LSB}}
                OE0# [symbol] 1
                OE1# [symbol] 0
```
where
n denotes the second count value,
DII denotes the dummy insertion indicator,
RA_{MSB} and RA0_{LSB} are concatenated into R_ADDR0, yielding the first output address for the first memory bank,
RA_{MSB} and RA1_{LSB} are concatenated into R_ADDR1, yielding the second output address for the second memory bank,
OE0# denotes the first output-enable signal,
OE1# denotes the second output-enable signal, and
N_{DBPS} is a prescribed number.

11. The de-interleaver as set forth in claim 8, wherein when the modulation mode is QPSK modulation and the coding rate is ½, the de-interleaving decoder generates the first output address, the second output address, the first output-enable signal, and the second output-enable signal, as described in the following pseudo-code:
```
for n = 0, 1, 2,..., N_{DBPS} − 1
  RA_{MSB} [symbol] n / 8
  RA0_{LSB} [symbol] n mod 8
  RA1_{LSB} [symbol] n mod 8
  R_ADDR0 [symbol] {RA_{MSB}, RA0_{LSB}}
  R_ADDR1 [symbol] {RA_{MSB}, RA1_{LSB}}
  OE0# [symbol] 0
  OE1# [symbol] 0
```
where
n denotes the second count value,
RA_{MSB} and RA0_{LSB} are concatenated into R_ADDR0, yielding the first output address for the first memory bank,
RA_{MSB} and RA1_{LSB} are concatenated into R_ADDR1, yielding the second output address for the second memory bank,
OE0# denotes the first output-enable signal,
OE1# denotes the second output-enable signal, and
N_{DBPS} is a prescribed number.

12. The de-interleaver as set forth in claim 8, wherein when the modulation mode is QPSK modulation and the coding rate is ¾, the de-interleaving decoder generates the first output address, the second output address, the first output-enable signal, and the second output-enable signal, as described in the following pseudo-code:
```
for n = 0, 1, 2,..., N_{DBPS} − 1
  if (DII = 00)
    RA_{MSB} [symbol] n / 12
    RA0_{LSB} [symbol] (n × 2 / 3) mod 8
    RA1_{LSB} [symbol] (n × 2 / 3) mod 8
    R_ADDR0 [symbol] {RA_{MSB}, RA0_{LSB}}
    R_ADDR1 [symbol] {RA_{MSB}, RA1_{LSB}}
    OE0# [symbol] 0
    OE1# [symbol] 0
  else if (DII = 01)
    RA_{MSB} [symbol] n / 12
    RA0_{LSB} [symbol] RA0_{LSB} + 1
    RA1_{LSB} [symbol] RA1_{LSB}
    R_ADDR0 [symbol] {RA_{MSB}, RA0_{LSB}}
    R_ADDR1 [symbol] {RA_{MSB}, RA1_{LSB}}
    OE0# [symbol] 0
    OE1# [symbol] 1
  else if (DII = 10)
    RA_{MSB} [symbol] n / 12
    RA0_{LSB} [symbol] RA0_{LSB}
    RA1_{LSB} [symbol] RA1_{LSB} + 1
    R_ADDR0 [symbol] {RA_{MSB}, RA0_{LSB}}
    R_ADDR1 [symbol] {RA_{MSB}, RA1_{LSB}}
    OE0# [symbol] 1
    OE1# [symbol] 0
```
where
n denotes the second count value,
DII denotes the dummy insertion indicator,
RA_{MSB} and RA0_{LSB} are concatenated into R_ADDR0, yielding the first output address for the first memory bank,
RA_{MSB} and RA1_{LSB} are concatenated into R_ADDR1, yielding the second output address for the second memory bank,
OE0# denotes the first output-enable signal,
OE1# denotes the second output-enable signal, and
N_{DBPS} is a prescribed number.

13. The de-interleaver as set forth in claim 8, wherein when the modulation mode is 16-QAM modulation and the coding rate is ½, the de-interleaving decoder generates the first output address, the second output address, the first output-enable signal, and the second output-enable signal, as described in the following pseudo-code:
```
for n = 0, 1, 2,..., N_{DBPS} − 1
  RA_{MSB} [symbol] n / 16
  RA0_{LSB} [symbol] n mod 8
  RA1_{LSB} [symbol] n mod 8
  R_ADDR0 [symbol] {RA_{MSB}, RA0_{LSB}}
  R_ADDR1 [symbol] {RA_{MSB}, RA1_{LSB}}
  OE0# [symbol] 0
  OE1# [symbol] 0
```
where
n denotes the second count value,
RA_{MSB} and RA0_{LSB} are concatenated into R_ADDR0, yielding the first output address for the first memory bank,
RA_{MSB} and RA1_{LSB} are concatenated into R_ADDR1, yielding the second output address for the second memory bank,
OE0# denotes the first output-enable signal,
OE1# denotes the second output-enable signal, and
N_{DBPS} is a prescribed number.

14. The de-interleaver as set forth in claim 8, wherein when the modulation mode is 16-QAM modulation and the coding rate is ¾, the de-interleaving decoder generates the first output address, the second output address, the first output-enable signal, and the second output-enable signal, as described in the following pseudo-code:
```
for n = 0, 1, 2,..., N_{DBPS} − 1
  if (DII = 00)
    RA_{MSB} [symbol] n / 24
    RA0_{LSB} [symbol] (n × 2 / 3) mod 8
    RA1_{LSB} [symbol] (n × 2 / 3) mod 8
    R_ADDR0 [symbol] {RA_{MSB}, RA0_{LSB}}
    R_ADDR1 [symbol] {RA_{MSB}, RA1_{LSB}}
    OE0# [symbol] 0
    OE1# [symbol] 0
  else if (DII = 01)
    RA_{MSB} [symbol] n / 24
    RA0_{LSB} [symbol] RA0_{LSB} + 1
    RA1_{LSB} [symbol] RA1_{LSB}
    R_ADDR0 [symbol] {RA_{MSB}, RA0_{LSB}}
    R_ADDR1 [symbol] {RA_{MSB}, RA1_{LSB}}
    OE0# [symbol] 0
    OE1# [symbol] 1
  else if (DII = 10)
    RA_{MSB} [symbol] n / 24
    RA0_{LSB} [symbol] RA0_{LSB}
    RA1_{LSB} [symbol] RA1_{LSB} + 1
    R_ADDR0 [symbol] {RA_{MSB}, RA0_{LSB}}
    R_ADDR1 [symbol] {RA_{MSB}, RA1_{LSB}}
    OE0# [symbol] 1
    OE1# [symbol] 0
```
where
n denotes the second count value,
DII denotes the dummy insertion indicator,
RA_{MSB} and RA0_{LSB} are concatenated into R_ADDR0, yielding the first output address for the first memory bank,
RA_{MSB} and RA1_{LSB} are concatenated into R_ADDR1, yielding the second output address for the second memory bank,
OE0# denotes the first output-enable signal,
OE1# denotes the second output-enable signal, and
N_{DBPS} is a prescribed number.

15. The de-interleaver as set forth in claim 8, wherein when the modulation mode is 64-QAM modulation and the coding rate is ⅔, the de-interleaving decoder generates the first output address, the second output address, the first output-enable signal, and the second output-enable signal, as described in the following pseudo-code:
```
for n = 0, 1, 2,..., N_{DBPS} − 1
  if (DII = 00)
    RA_{MSB} [symbol] n / 32
    RA0_{LSB} [symbol] (n × 3 / 4) mod 8
    RA1_{LSB} [symbol] (n × 3 / 4) mod 8
    R_ADDR0 [symbol] {RA_{MSB}, RA0_{LSB}}
    R_ADDR1 [symbol] {RA_{MSB}, RA1_{LSB}}
    OE0# [symbol] 0
    OE1# [symbol] 0
  else if (DII = 01)
    RA_{MSB} [symbol] n / 32
    RA0_{LSB} [symbol] RA0_{LSB} + 1
    RA1_{LSB} [symbol] RA1_{LSB}
    R_ADDR0 [symbol] {RA_{MSB}, RA0_{LSB}}
    R_ADDR1 [symbol] {RA_{MSB}, RA1_{LSB}}
    OE0# [symbol] 0
    OE1# [symbol] 1
  else if (DII = 11)
    RA_{MSB} [symbol] n / 32
    RA0_{LSB} [symbol] RA0_{LSB} + 1
    RA1_{LSB} [symbol] RA1_{LSB} + 1
    R_ADDR0 [symbol] {RA_{MSB}, RA0_{LSB}}
    R_ADDR1 [symbol] {RA_{MSB}, RA1_{LSB}}
    OE0# [symbol] 0
    OE1# [symbol] 0
  else if (DII = 10)
    RA_{MSB} [symbol] n / 32
    RA0_{LSB} [symbol] RA0_{LSB}
    RA1_{LSB} [symbol] RA1_{LSB} + 1
    R_ADDR0 [symbol] {RA_{MSB}, RA0_{LSB}}
    R_ADDR1 [symbol] {RA_{MSB}, RA1_{LSB}}
    OE0# [symbol] 1
    OE1# [symbol] 0
```
where
n denotes the second count value,
DII denotes the dummy insertion indicator,
RA_{MSB} and RA0_{LSB} are concatenated into R_ADDR0, yielding the first output address for the first memory bank,
RA_{MSB} and RA1_{LSB} are concatenated into R_ADDR1, yielding the second output address for the second memory bank,
OE0# denotes the first output-enable signal,
OE1# denotes the second output-enable signal, and
N_{DBPS} is a prescribed number.

16. The de-interleaver as set forth in claim 8, wherein when the modulation mode is 64-QAM modulation and the coding rate is ¾, the de-interleaving decoder generates the first output address, the second output address, the first output-enable signal, and the second output-enable signal, as described in the following pseudo-code:
```
for n = 0, 1, 2,..., N_{DBPS} − 1
  if (DII = 00)
    RA_{MSB} [symbol] n / 36
    RA0_{LSB} [symbol] (n × 2 / 3) mod 8
    RA1_{LSB} [symbol] (n × 2 / 3) mod 8
    R_ADDR0 [symbol] {RA_{MSB}, RA0_{LSB}}
    R_ADDR1 [symbol] {RA_{MSB}, RA1_{LSB}}
    OE0# [symbol] 0
    OE1# [symbol] 0
  else if (DII = 01)
    RA_{MSB} [symbol] n / 36
    RA0_{LSB} [symbol] RA0_{LSB} + 1
    RA1_{LSB} [symbol] RA1_{LSB}
    R_ADDR0 [symbol] {RA_{MSB}, RA0_{LSB}}
    R_ADDR1 [symbol] {RA_{MSB}, RA1_{LSB}}
    OE0# [symbol] 0
    OE1# [symbol] 1
  else if (DII = 10)
    RA_{MSB} [symbol] n / 36
    RA0_{LSB} [symbol] RA0_{LSB}
    RA1_{LSB} [symbol] RA1_{LSB} + 1
    R_ADDR0 [symbol] {RA_{MSB}, RA0_{LSB}}
    R_ADDR1 [symbol] {RA_{MSB}, RA1_{LSB}}
    OE0# [symbol] 1
    OE1# [symbol] 0
```
where
n denotes the second count value,
DII denotes the dummy insertion indicator,
RA_{MSB} and RA0_{LSB} are concatenated into R_ADDR0, yielding the first output address for the first memory bank,
RA_{MSB} and RA1_{MSB} are concatenated into R_ADDR1, yielding the second output address for the second memory bank,
OE0# denotes the first output-enable signal,
OE1# denotes the second output-enable signal, and
N_{DBPS} is a prescribed number.

17. A multi-carrier communications system comprising a de-interleaver for data decoding, the de-interleaver comprising:
first and second memory banks configured to store data in column order and output the data in row order;
a de-interleaving encoder receiving a stream of interleaved data values, generating an input address for both the first and the second memory banks contingent upon a modulation mode and based on a first count value, and sequentially writing the interleaved data values to either the first memory bank or the second memory bank in column order according to the input address; and
a de-interleaving decoder generating a first output address for the first memory bank and a second output address for the second memory bank based on a second count value and contingent upon the modulation mode, a coding rate, and a dummy insertion indicator, reading the interleaved data values from the first and the second memory banks in row order according to the first output address and the second output address, respectively, and extracting decision metrics from the interleaved data values read out of the first and the second memory banks according to a first output indicator and a second output indicator.
